(19) United States
(12) Patent Application Publication
(10) Pub. No.: US 2010/0138577 A1
(43) Pub. Date: Jun. 3, 2010

(54) APPARATUS AND METHOD FOR WRITING BITWISE DATA IN SYSTEM ON CHIP

(75) Inventors: Jong-Hyuck HONG, Suwon-si (KR); In-Kwon PAIK, Yongin-si (KR); Tae-Hong PARK, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/627,441

(22) Filed: Nov. 30, 2009

(30) Foreign Application Priority Data
Dec. 3, 2008 (KR) 10-2008-0121630

(51) Int. Cl. G06F 13/40

(52) U.S. Cl. 710/110

(57) ABSTRACT

An apparatus and a method for writing bitwise data in a System On Chip (SOC) are provided. In the method, a master determines whether a size of data to be written on a slave is equal to or smaller than half of a size of data transmittable at a time. If it is determined that the data is equal to or smaller than half of the size of the data transmittable at a time, the master transmits the data to the slave via a bus. The master transmits a signal representing a bit at which the data is to be written via a bus lane not used for the data transmission.

### PRIORITY

This application claims the benefit under 35 U.S.C. §119(a) of a Korean patent application filed in the Korean Intellectual Property Office on Dec. 3, 2008 and assigned Serial No. 10-2008-0121630, the entire disclosure of which is hereby incorporated by reference.

### BACKGROUND OF THE INVENTION

1. Field of the Invention

The present invention relates to an apparatus and a method for writing bitwise data in a System On Chip (SOC). More particularly, the present invention relates to an apparatus and a method for performing data transaction on a bit basis between a master and a slave.

2. Description of the Related Art

Recently, an SOC, in which a computing system is realized and provided in one semiconductor chip, is under development. In the SOC, various functional blocks, also called Intellectual Property (IP) blocks, are integrated in a semiconductor chip. The functional blocks are divided into blocks for operating as a master with respect to a bus, and slave functional blocks for serving as objects of the operation of the master.

FIG. 1 is a block diagram illustrating a conventional Advanced Microprocessor Bus Architecture (AMBA) bus system.

Referring to FIG. 1, the conventional bus system includes a bus 110, a plurality of masters 100, 102, and 104, and a plurality of slaves 120, 122, 124, and 126. The plurality of masters 100, 102, and 104 write data on the plurality of slaves 120, 122, 124, and 126, or read data stored in the plurality of slaves 120, 122, 124, and 126 using the bus 110.

The AMBA bus system provides three kinds of different bus protocols. Some of the protocols have a signal representing a size of a data transaction currently in progress and can perform a data transaction on a byte basis. Some of the protocols do not have a defined signal that can express the size, so that they perform a data transaction on the entire data width of the bus. This applies likewise to the conventional bus protocol of a different kind.

As described above, most of the conventional bus systems operate on a byte basis. That is, the conventional bus protocol does not support data transaction of less than 1 byte. Therefore, in the case where the master intends to change only a value corresponding to 1 bit of a value stored at a specific address of a slave, the master must pass through a complicated procedure.

FIG. 2 is a diagram illustrating a procedure for processing data of less than 1 byte in a conventional bus system.

Referring to FIG. 2, a master 200 can perform a data transaction of less than 1 byte by reading a value of a relevant address from a slave 202, storing the value in a temporary storage space, and performing an operation of changing a bit to be changed in the value stored in the temporary storing space in steps 210 and 220, and storing an operation result value in the slave 202 in step 230.

As described above, since the conventional bus system provides a data transaction performed on a byte basis, the conventional bus system must execute a complicated process of reading the data, performing an operation using the data, and writing the data in order to perform a data transaction of less than 1 byte. Based on this operating process, although a data read operation, which the master intends to perform, is an operation processable within a very short time, a performance time of the data read operation is long, so that the entire consumed time is lengthened, and thus power consumption is inefficient. In addition, the master must perform an operation using the data in order to perform a data write operation. Since the operation using the data is difficult for simple hardware to perform, hardware such as a Central Processing Unit (CPU) that can perform a complicated operation is required to be used. The use of the CPU causes a delay to an operation which the CPU has been processing originally. In addition, in the conventional bus system, while a specific master performs the above three processes on data of a specific slave, the data of the specific slave may be changed by a different master, but the specific master cannot reflect the changed data. Consequently, a system error may occur.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for writing bitwise data in an SOC.

Another aspect of the present invention is to provide an apparatus and a method for performing a data transaction on a bit basis between a master and a slave in a bus system.

Still another aspect of the present invention is to provide an apparatus and a method for performing a data transaction on a bit basis by transmitting a signal representing bit selection to some of data transmission lanes in a bus system.

In accordance with an aspect of the present invention, a method for writing data on a bit basis in a System On Chip (SOC) is provided. The method includes determining, by a master, a size of write data with a size of data transmittable at a time, if it is determined that the size of the write data is equal to or smaller than half of the size of the data transmittable at a time, transmitting, by the master, the write data to a slave via some of data lanes via which data is transmitted to the slave, and transmitting, by the master, a bit selection signal representing a bit at which the write data is to be written to the slave via remaining data lanes not used for the write data transmission.

In accordance with another aspect of the present invention, an apparatus for writing data on a bit basis in a System On Chip (SOC) is provided. The apparatus includes a master for determining a size of write data with a size of data transmittable at a time, if it is determined that the size of the write data is equal to or smaller than half of the size of the data transmittable at a time, for outputting the write data via some of data lanes via which data is transmitted, and for outputting a bit selection signal representing a bit at which write data is to be written via a remaining data lane, and a slave for receiving write data and a bit selection signal from the master, and for processing the same.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a conventional Advanced Microprocessor Bus Architecture (AMBA) bus system;

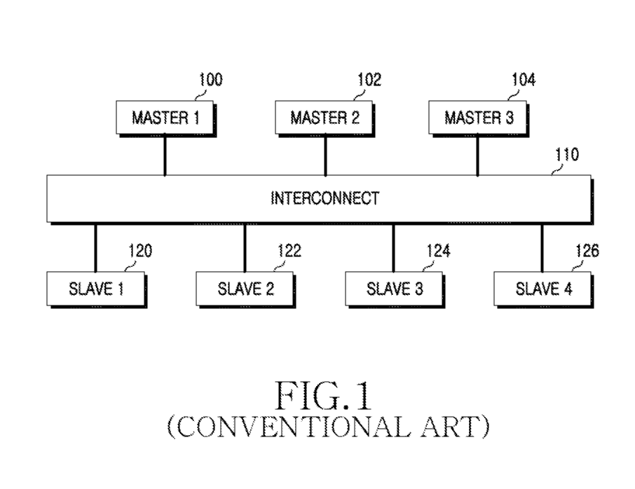

FIG. 2 is a diagram illustrating a procedure for processing data of 1 byte in a conventional bus system;

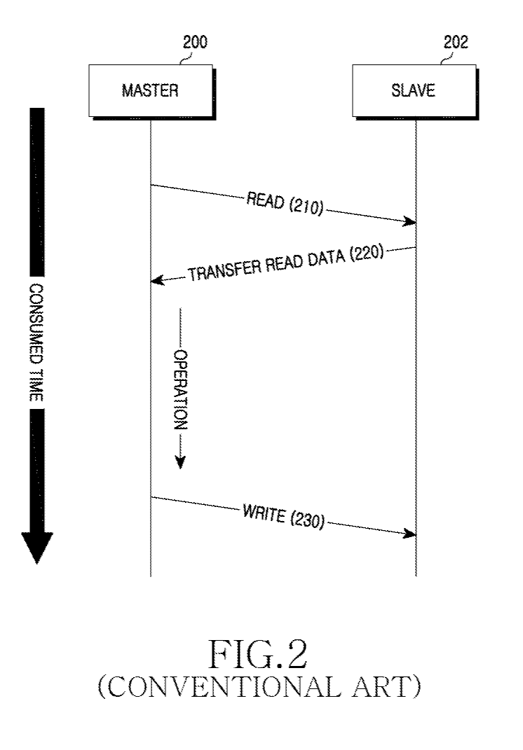

FIG. 3 is a diagram illustrating a structure of a conventional bus system;

FIG. 4 is a diagram illustrating a structure of a bus system according to an exemplary embodiment of the present invention;

FIG. 5 is a diagram illustrating a bus system for performing a data transaction on a bit basis according to an exemplary embodiment of the present invention; and

FIG. 6 is a flowchart illustrating a procedure for performing a data transaction on a bit basis in a bus system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for performing a data transaction on a bit basis by transmitting a signal representing bit selection to some of data transmission lanes in a bus system.

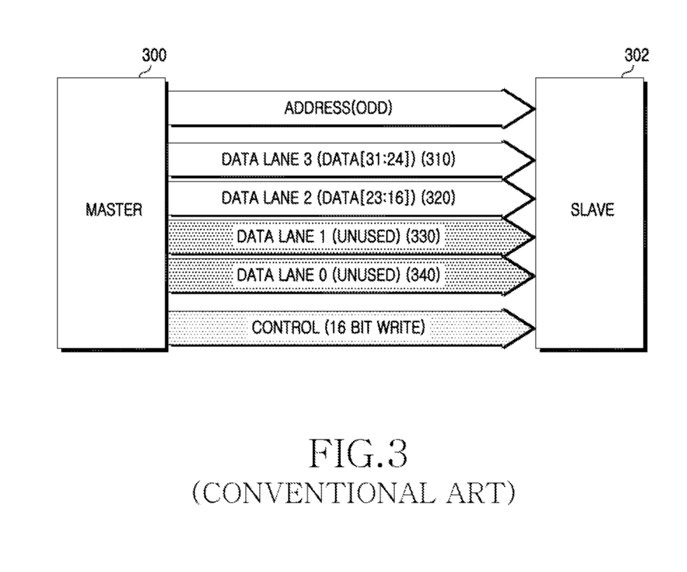

FIG. 3 is a diagram illustrating a structure of a conventional bus system.

Referring to FIG. 3, in the conventional bus system, data lanes 310, 320, 330, and 340 of 32 bits are connected between a master 300 and a slave 302. In this structure, in a case where the master 300 intends to perform a data transaction of less than 16 bits on the slave 302, the master 300 uses only the data lanes 310 and 320 corresponding to 16 bits among the data lanes 310, 320, 330, and 340 of 32 bits in order to transmit data, and does not use the remaining data lanes 330 and 340 corresponding to 16 bits.

Therefore, an exemplary embodiment of the present invention intends to perform a data transaction on a bit basis by additionally indicating a data bit selection signal to some of the data lanes unused for the data transmission. An exemplary embodiment of the present invention is described using a case where data lanes are 32 bits in a bus system as an example, and is applicable to a case where the number of bits forming the data lanes is different.

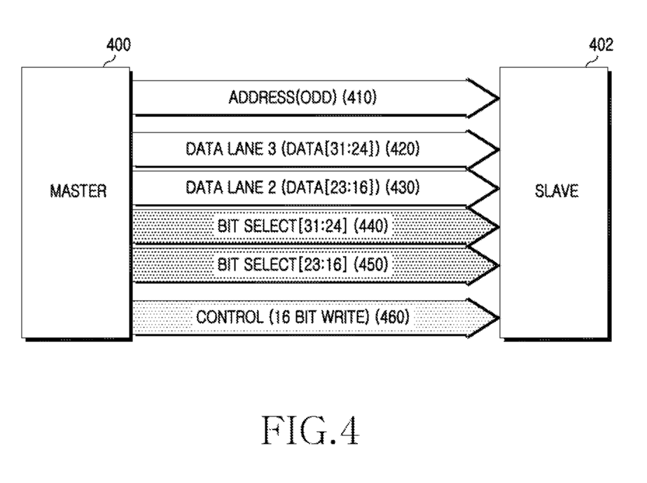

FIG. 4 is a diagram illustrating a structure of a bus system according to an exemplary embodiment of the present invention.

Referring to FIG. 4, the bus system includes a master 400, a slave 402, an address lane 410, bus lanes 420 to 450, and a control lane 460. The master 400 performs an operation of writing data on the slave 402, or reading data recorded in advance on the slave 402. When a data write event occurs on the slave 402, the master 400 determines whether to perform a write operation on a bit basis by determining a size of relevant data. At this point, when the size of the data is equal to or less than half of the size of data transmittable at a time, the master 400 may determine to perform a write operation on a bit basis. For example, when an entire data transmission lane is 32 bits, the master 400 may determine to perform a write operation on a bit basis if data on which the write operation is to be performed (referred to as ‘write data’) is less than 16 bits.

When the write operation on a bit basis is determined, the master 400 determines transmission data lanes 420 and 430 to which the write data is to be transmitted, and non-transmission data lanes 440 and 450 unused for the write data transmission, and then transmits the write data to the transmission data lanes 420 and 430, and transmits a bit selection signal representing a bit location at which the write data is to be written to the non-transmission data lanes 440 and 450. At this point, the master 400 may determine the transmission data lanes and the non-transmission data lanes depending on an address at which the write data is to be written, that is, a destination address. For example, when a destination address of the write data is an odd number, the master 400 may determine data lanes of upper 16 bits among the data lanes of 32 bits as transmission data lanes, and determine data lanes of lower 16 bits as non-transmission data lanes. In contrast, when the destination address of the write data is an even number, the master 400 may determine data lanes of upper 16 bits among the data lanes of 32 bits as the non-transmission data lanes, and determine data lanes of lower 16 bits as transmission data lanes. Of course, the transmission data lanes and the non-transmission data lanes may be determined using various methods.

In addition, the master 400 transmits an address 410 at which the write data is to be written, and a control signal 460 representing a size of the write data and the kind of a data transaction to the slave 402.

The slave 402 records data information transmitted by the master 400 via a bus at a relevant address. That is, the slave 402 determines a destination address of write data, data on which a write operation is to be performed, a bit selection signal representing a location at which the data is to be written, and a control signal representing a size of the data and a data transaction operation transmitted by the master 400 via the bus. The slave 402 then determines a bit on which a data transaction operation is to be performed from the destination address and the bit selection signal, and performs the data transaction operation on a bit corresponding to the bit selection signal among data recorded at the destination address.

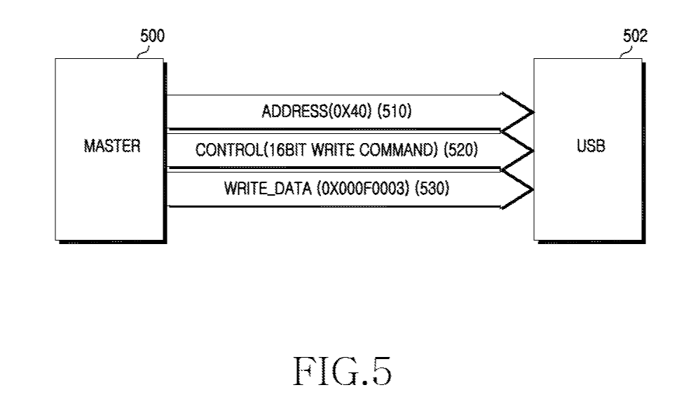

An example in which a master performs a data write operation on a slave is described with reference to FIG. 5 based on the above description.

FIG. 5 is a diagram illustrating a bus system for performing a data transaction on a bit basis according to an exemplary embodiment of the present invention. Here, a case where a slave is a Universal Serial Bus (USB) 502 is described for example.

Referring to FIG. 5, a master 500 intends to change a value corresponding to lower 4 bits of a value stored at an address 0x40 of the USB 502 into 0x3. At this point, the value stored at the address 0x40 of the USB 502 is 0x8730, and the master 500 does not know this value.

Since a destination address is 0x40, which is an even number, the master 500 determines lower 16 bits of data transmission lanes as transmission data lanes, determines upper 16 bits as non-transmission data lanes, transmits 0x3, which is the value to be changed, to the lower 16 bits, and transmits a bit selection signal representing a bit location at which 0x3 is to be written to the upper 16 bits. That is, the master 500 transmits an address signal 510 representing that a destination address is ‘0x40’, a control signal 520 representing performing of a write operation, and a write data signal 530 of ‘0x000F0003’ representing that a value corresponding to the lower 4 bits is changed to 0x3 to the USB 502.

Then, since upper 16 bits of ‘0x000F0003’ is 0xF, the USB 502 recognizes that lower 4 bits of data stored at the address 0x40 should be updated, and replaces the lower 4 bits of the address 0x40 by 0x3 represented by lower 16 bits of ‘0x000F0003’. Accordingly, only lower 4 bits of 0x8730 stored at the address 0x40 are replaced by 3, so that a value stored at the address of 0x40 becomes 0x8733.

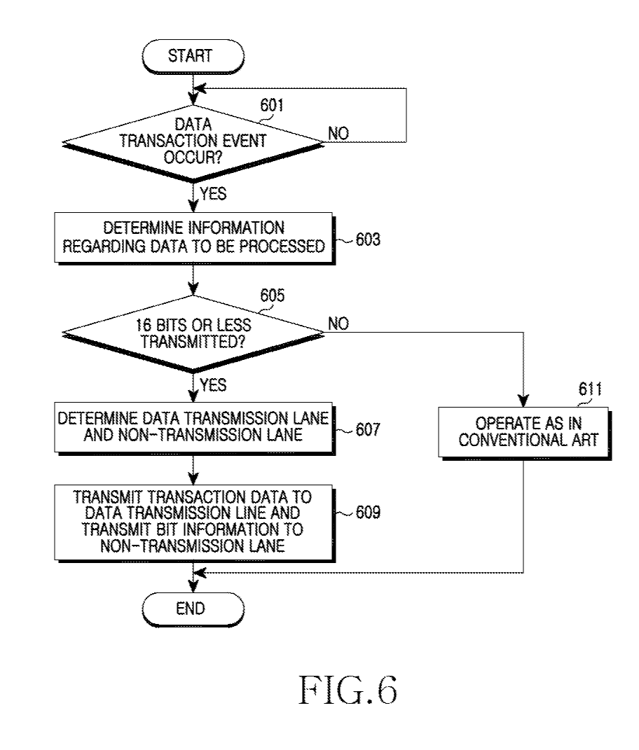

FIG. 6 is a flowchart illustrating a procedure for performing a data transaction on a bit basis in a bus system according to an exemplary embodiment of the present invention.

Referring to FIG. 6, a master determines whether a data transaction event for writing data on a slave occurs in step 601. If it is determined that the data transaction event occurs, the master determines information regarding data to be processed in step 603. For example, the master determines that a destination address of a slave, at which the data is to be written, is 0x40, the size of the data to be written on the slave is 4 bits, and a data value is 0x3.

The master determines whether the size of the data to be processed is 16 bits or less based on the information regarding the determined data in step 605. That is, the master determines whether the size of the data, on which a write operation is to be performed, is equal to or less than ½ of the size of data transmittable at a time.

If it is determined that the size of the data to be processed is 16 bits or less, the master determines transmission data lanes to be used for data transmission and non-transmission data lanes unused for the data transmission in step 607. At this point, the master may determine transmission data lanes and non-transmission data lanes depending on a destination address at which the data is to be written. For example, if it is determined that a destination address of the write data is an odd number, the master may determine data lanes of upper 16 bits among the data lanes of 32 bits as transmission data lanes, and may determine data lanes of lower 16 bits as non-transmission data lanes. In contrast, if it is determined that the destination address is an even number, the master may determine data lanes of upper 16 bits among the data lanes of 32 bits as the non-transmission data lanes, and may determine data lanes of lower 16 bits as transmission data lanes.

The master transmits the data to the transmission data lanes, transmits bit information representing a bit location at which the data is to be written to the non-transmission data lanes in step 609, and ends the algorithm according to an exemplary embodiment of the present invention.

In contrast, if it is determined that the size of the data to be processed is more than 16 bits, the master performs a data write operation by performing three operations of reading the data, performing an operation on the data, and writing the data in step 611 as in the conventional art, and the process ends.

Exemplary embodiments of the present invention may reduce a time taken for performing a data transaction on a bit basis and simultaneously save power consumption by transmitting a signal representing bit selection to some of data transmission lanes in a bus system. In addition, since a data operation process performed when data is processed on a bit basis in the conventional bus system is not required, the load on a CPU is reduced, so that a system may operate more stably. In addition, a margin that may lower an operation frequency is provided, so that a low power operation is possible.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for writing data on a bit basis in a System On Chip (SOC), the method comprising:
determining, by a master, a size of write data with a size of data transmittable at a time;
if it is determined that the size of the write data is equal to or smaller than half of the size of the data transmittable at a time, transmitting, by the master, the write data to a slave via some of data lanes via which data is transmitted to the slave; and
transmitting, by the master, a bit selection signal representing a bit at which the write data is to be written to the slave via remaining data lanes not used for the write data transmission.

2. The method of claim 1, further comprising determining, by the master, a data lane to which the write data is to be transmitted and a data lane to which the bit selection signal is to the transmitted depending on a destination address of the write data.

3. The method of claim 2, wherein the data lane is determined depending on whether the destination address is an odd number or an even number.

4. The method of claim 1, further comprising transmitting, by the master, a control signal for processing the write data to the slave.

5. The method of claim 4, wherein the control signal comprises at least one of an address at which the write data is to be written, a size of the write data, and a kind of a data transaction.

6. An apparatus for writing data on a bit basis in a System-On-Chip (SOC), the apparatus comprising:
a master for determining a size of write data with a size of data transmittable at a time, for, if it is determined that the size of the write data is equal to or smaller than half of the size of the data transmittable at a time, outputting the write data via some of data lanes via which data is transmitted, and for outputting a bit selection signal representing a bit at which write data is to be written via remaining data lanes; and
a slave for receiving write data and a bit selection signal from the master, and for processing the same.

7. The apparatus of claim 6, wherein the master determines a data lane to which the write data is to be transmitted and a data lane to which the bit selection signal is to the transmitted depending on a destination address of the write data.

8. The apparatus of claim 7, wherein the master determines the data lane depending on whether the destination address is an odd number or an even number.

9. The apparatus of claim 6, wherein the master transmits a control signal for processing the write data to the slave.

10. The apparatus of claim 9, wherein the control signal comprises at least one of an address at which the write data is to be written, a size of the write data, and a kind of a data transaction.
